(19) United States
(12) Patent Application Publication
(10) Pub. No.: US 2025/0218318 A1
(43) Pub. Date: Jul. 3, 2025

(54) DISPLAY DEVICE AND DISPLAY METHOD

(71) Applicant: JVCKENWOOD Corporation, Yokohama-shi (JP)

(72) Inventors: Hiroyuki Takada, Yokohama-shi (JP); Takaaki Saiki, Yokohama-shi (JP)

(21) Appl. No.: 19/064,921

(22) Filed: Feb. 27, 2025

Related U.S. Application Data
(63) Continuation of application No. PCT/JP2023/015560, filed on Apr. 19, 2023.

(30) Foreign Application Priority Data
Aug. 31, 2022 (JP) 2022-138534

(51) Int. Cl. G09G 3/00

(52) U.S. Cl. CPC G09G 3/001; G09G 2340/0407; G09G 2340/16

(57) ABSTRACT

Smooth display of a moving image is enabled with adequate gradation maintained. A processing unit that controls a display element on the basis of image data, and a control unit that controls the processing unit are included, and the control unit obtains an amount of movement from image data in a first frame and image data in a second frame after the first frame, sets, on the basis of the amount of movement, the number of subframes for the second frame, the subframes being for display of some of pixels included in the image data on the second frame, and causes the processing unit to control the display element such that the subframes set for the second frame are displayed in a time period for display of the second frame.

### CROSS-REFERENCE TO RELATED APPLICATIONS

This application is a Continuation of PCT International Application No. PCT/JP2023/015560 filed on Apr. 19, 2023 which claims the benefit of priority from Japanese Patent Application No. 2022-138534 filed on Aug. 31, 2022, the entire contents of both of which are incorporated herein by reference.

### BACKGROUND OF THE INVENTION

### 1. Field of the Invention

The present invention relates to a display device and a display method.

### 2. Description of the Related Art

In a technique related to an image display device using a liquid crystal display element, for example, in order to artificially increase resolution, a display time period for one frame is divided into display time periods for plural subframes, an optical path control device is controlled such that projection on a screen is performed per display time period of each subframe but its position is shifted, and the number of pixels projected is thereby made to appear larger than the number of pixels of an optical modulation element thereof. For example, such a technique is described in Japanese Patent No. 3863445.

In such a method of displaying by division of a display time period for one frame into display time periods for plural subframes, there is a demand for adequately displaying a moving image with adequate gradation maintained.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A display device according to the present disclosure comprising: a processing unit that controls a display element on the basis of image data; and a control unit that controls the processing unit, wherein the control unit obtains an amount of movement from the image data in a first frame and the image data in a second frame after the first frame, sets the number of subframes for the second frame on the basis of the amount of movement, the subframes being for display of some of pixels included in the image data on the second frame, and causes the processing unit to control the display element such that the subframes set for the second frame are displayed in a time period for display of the second frame.

A display method according to the present disclosure including: a step of obtaining an amount of movement from image data in a first frame and the image data in a second frame after the first frame; a step of setting the number of subframes for the second frame on the basis of the amount of movement, the subframes being for display of some of pixels included in the image data on the second frame; and a step of controlling a display element such that the subframes set for the second frame are displayed in a time period for display of the second frame.

### BRIEF DESCRIPTION OF THE DRAWINGS

FIG. 1 is a schematic diagram illustrating a display device according to a first embodiment;

FIG. 2 is a block diagram schematically illustrating circuitry of the display device;

FIG. 3 is a plan view illustrating an optical path control mechanism;

FIG. 4 is a sectional view taken on a line IV-IV in FIG. 3;

FIG. 5 is a sectional view taken on a line V-V in FIG. 3;

FIG. 6 is a graph illustrating a waveform of a driving signal of a driving unit;

FIG. 7 is a graph illustrating a monoaxial swinging pattern of an optical unit;

FIG. 8 is a diagram illustrating a biaxial swinging pattern of the optical unit;

FIG. 9 is a graph illustrating the biaxial swinging pattern of the optical unit;

FIG. 10 is a diagram illustrating a frame division configuration by a processing unit;

FIG. 11 is a diagram for description of an example of a display method for subframes, according to the first embodiment;

FIG. 12 is a schematic diagram illustrating an example of image display in a case where a motion vector is larger than a threshold;

FIG. 13 is a schematic diagram illustrating an example of image display in a case where the motion vector is equal to or less than the threshold;

FIG. 14 is a schematic diagram illustrating an example of image display in the case where the motion vector is equal to or less than the threshold; and

FIG. 15 is a schematic diagram illustrating another example of order of pixels displayed.

### DETAILED DESCRIPTION OF THE PREFERRED EMBODIMENTS

Embodiments will be described hereinafter in detail by reference to the appended drawings. The embodiments are not to be limited by the following embodiments.

### First Embodiment

### Schematic Configuration of Display Device

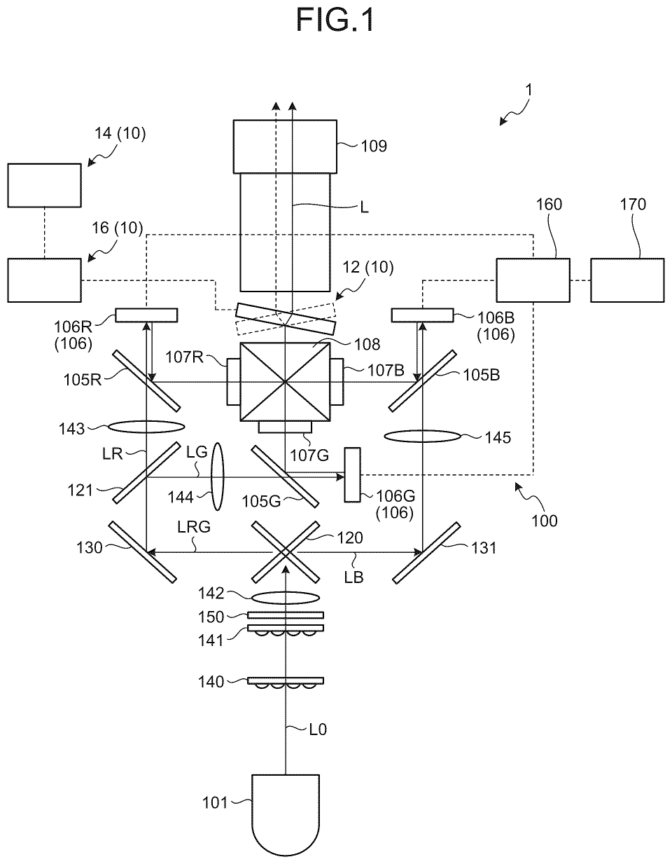

FIG. 1 is a schematic diagram of a display device according to a first embodiment.

In this embodiment, as illustrated in FIG. 1, a display device 1 has an optical path control device 10, an irradiation device 100, a video signal processing circuit (processing unit) 160, and a control unit 170 that controls the video signal processing circuit 160. The irradiation device 100 is a device that emits light L for images. The optical path control device 10 is a device that controls optical paths of the light L. By shifting an optical axis of the light L, the optical path control device 10 shifts the position of an image displayed by means of the light L and thereby makes the resolution of a projected image higher than the resolution (that is, the numbers of pixels of display elements 106 described later) of the image formed by the irradiation device 100.

The irradiation device 100 includes a light source 101, polarizing plates 105R, 105G, and 105B, display elements 106R, 106G, and 106B, polarizing plates 107R, 107G, and 107B, a color combining prism 108, a projection lens 109, dichroic mirrors 120 and 121, reflecting mirrors 130 and 131, lenses 140, 141, 142, 143, 144, and 145, a polarization conversion element 150, and the video signal processing circuit 160. In a case where the display element 106R, the display element 106G, and the display element 106B are not to be distinguished from one another, they will be referred to as the display elements 106.

The light source 101 is a light source that generates and emits light. The light source 101 emits incident light L0. In the following description, use of a single light source 101 as a light source to emit the incident light L0 will be described as an example, but another optical device for generating the incident light L0 may be included.

The incident light L0 from the light source 101 is incident on the lens 140. The lens 140 and the lens 141 are, for example, fly-eye lenses. The illumination distribution of the incident light L0 is uniformized by the lenses 140 and 141 and is then incident on the polarization conversion element 150. The polarization conversion element 150 is an element that makes polarization of the incident light L0 uniform, and has, for example, a polarization beam splitter and a phase difference plate. For example, the polarization conversion element 150 converts the incident light L0 to p-polarized light.

The incident light L0 uniformized in polarization by the polarization conversion element 150 is input to the dichroic mirror 120 via the lens 142. The lens 142 is, for example, a condenser lens.

The dichroic mirror 120 separates the incident light L0 incident thereon into yellow light LRG and blue light LB including a blue band component. The yellow illumination light LRG separated by the dichroic mirror 120 is reflected by the reflecting mirror 130 and is then input to the dichroic mirror 121.

The dichroic mirror 121 separates the yellow light LRG incident thereon into red light LR including a red band component and green light LG including a green band component.

The red light LR separated by the dichroic mirror 121 is input to the polarizing plate 105R via the lens 143. The green light LG separated by the dichroic mirror 121 is input the polarizing plate 105G via the lens 144. The blue light LB separated by the dichroic mirror 120 is reflected by the reflecting mirror 131 and then input to the polarizing plate 105B via the lens 145.

The polarizing plates 105R, 105G, and 105B have a characteristic of reflecting one of s-polarized light and p-polarized light and transmitting the other one of the s-polarized light and p-polarized light therethrough. For example, the polarizing plates 105R, 105G, and 105B have a characteristic of reflecting s-polarized light and transmitting p-polarized light therethrough. The polarizing plates 105R, 105G, and 105B are also referred to as reflective polarizing plates.

The red light LR that is p-polarized light is transmitted through the polarizing plate 105R and input to the display element 106R. The green light LG that is p-polarized light is transmitted through the polarizing plate 105G and input to the display element 106G. The blue light LB that is p-polarized light is transmitted through the polarizing plate 105B and input to the display element 106B.

The display element 106R, the display element 106G, and the display element 106B are, for example, reflective liquid crystal display elements. A case where the display elements 106R, the display element 106G, and the display element 106B are reflective liquid crystal display elements will be described hereinafter as an example but without being limited to this reflective type, a configuration using transmission liquid crystal may be adopted. Furthermore, various configurations using other display elements and not liquid crystal display elements are also applicable.

The display element 106R is controlled by the video signal processing circuit 160. On the basis of image data of a red component, the video signal processing circuit 160 controls driving of the display element 106R. The display element 106R optically modulates the p-polarized red light LR according to the control by the video signal processing circuit 160 and generates s-polarized red light LR. The display element 106G is controlled by the video signal processing circuit 160. On the basis of image data of a green component, the video signal processing circuit 160 controls driving of the display element 106G. The display element 106G optically modulates the p-polarized green light LG according to the control by the video signal processing circuit 160 and generates s-polarized green light LG. The display element 106B is controlled by the video signal processing circuit 160. On the basis of image data of a blue component, the video signal processing circuit 160 controls driving of the display element 106B. The display element 106B optically modulates the p-polarized blue light LB according to the control by the video signal processing circuit 160 and on the basis of the image data of the blue component, and generates s-polarized blue light LB.

The polarizing plates 107R, 107G, and 107B have a characteristic of transmitting one of s-polarized light and p-polarized light therethrough and reflecting or absorbing the other one of the s-polarized light and p-polarized light. For example, the polarizing plates 107R, 107G, and 107B transmit s-polarized light and absorb unnecessary p-polarized light.

The s-polarized red light LR generated by the display element 106R is reflected by the polarizing plate 105R, transmitted through the polarizing plate 107R, and input to the color combining prism 108. The s-polarized green light LG generated by the display element 106G is reflected by the polarizing plate 105G, transmitted through the polarizing plate 107G, and input to the color combining prism 108. The s-polarized blue light LB generated by the display element 106B is reflected by the polarizing plate 105B, transmitted through the polarizing plate 107B, and input to the color combining prism 108.

The color combining prism 108 combines the red light LR, the green light LG, and the blue light LB incident thereon and outputs the combined light as the light L for image display to the projection lens 109. The light L is projected onto, for example, a screen not illustrated in the drawings, via the projection lens 109.

The irradiation device 100 has the above described configuration but may have any configuration without being limited to the above described configuration.

The optical path control device 10 has an optical path control mechanism 12, a control circuit (control unit) 14, and a driving circuit (driving unit) 16. The optical path control mechanism 12 is a mechanism that swings by being driven by the driving circuit 16. The optical path control mechanism 12 is provided between the color combining prism 108 and the projection lens 109 along the optical path of the light L. The optical path control mechanism 12 shifts the direction of travel (optical path) of the light L from the color combining prism 108 to output the light L to the projection lens 109 by swinging while the light L is being incident on the optical path control mechanism 12.

### Functional Configuration of Display Device

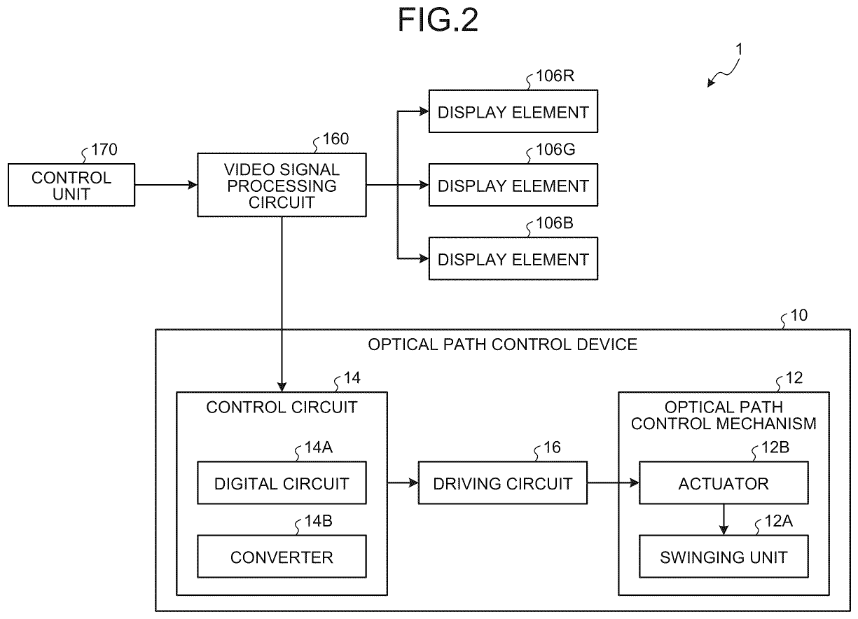

FIG. 2 is a block diagram schematically illustrating circuitry of the display device.

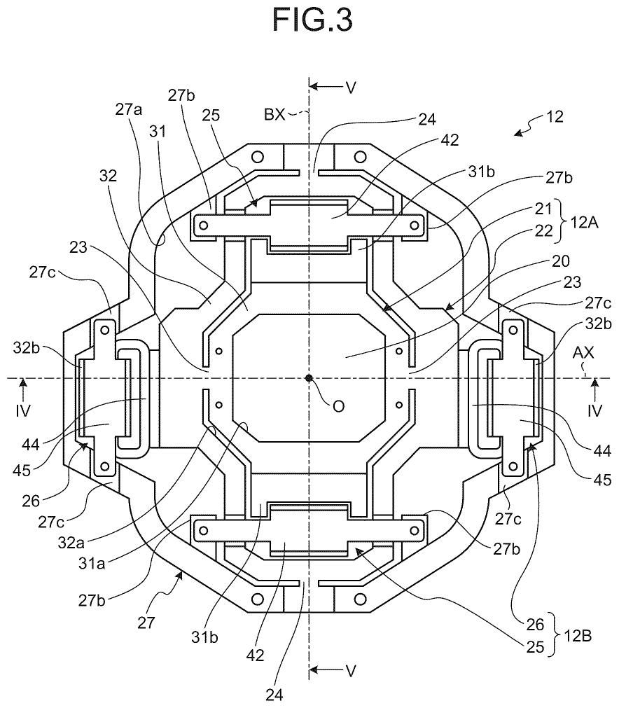

As illustrated in FIG. 2, the video signal processing circuit 160 controls the display elements 106R, 106B, and 106G. Video signals including image data for controlling the display elements 106R, 106B, and 106G and a synchronization signal are input to the video signal processing circuit 160. The video signal processing circuit 160 controls the display elements 106R, 106B, and 106G on the basis of the image data while synchronizing the timing on the basis of the synchronization signal. The control circuit 14 has a digital circuit 14A and a converter 14B. The synchronization signal from the video signal processing circuit 160 is input to the digital circuit 14A. The digital circuit 14A generates a digital driving signal for driving the optical path control mechanism 12 while synchronizing the timing on the basis of the synchronization signal. The converter 14B is a DA converter that converts a digital signal to an analog signal. The converter 14B converts a digital driving signal generated by the digital circuit 14A to an analog driving signal. The analog driving signal from the converter 14B is input to the driving circuit 16, and the driving circuit 16 amplifies the analog driving signal and outputs the amplified analog driving signal to an actuator 12B of the optical path control mechanism 12 described later. The actuator 12B swings a swinging unit 12A (see FIG. 3) described later, by being driven according to the driving signal.

The control unit 170 is a device that controls the video signal processing circuit 160. The control unit 170 is, for example, a computer, and has a storage unit and a processing unit, which are not illustrated in the drawings. The storage unit that the control unit 170 has is a memory that stores various kinds of information, such as content of calculation by the processing unit and programs for the processing unit, and includes, for example, at least one of: a random access memory (RAM); a main storage device, such as a read only memory (ROM); and an external storage device, such as a hard disk drive (HDD). The programs stored in the storage unit may be stored in a recording medium that is able to be read by the control unit 170, the programs being for the processing unit. The processing unit that the control unit 170 has is a processing device that executes calculation, and includes a calculation circuit, such as a central processing unit (CPU), for example. By reading and executing the programs (software) from the storage unit, the processing unit executes processing by means of the control unit 170. The control unit 170 may execute the processing by means of a single CPU, or may include plural CPUs and execute the processing by means of these plural CPUs. At least part of the processing executed by the control unit 170 may be implemented by a hardware circuit. The processing executed by the control unit 170 will be described later.

### Optical Path Control Mechanism

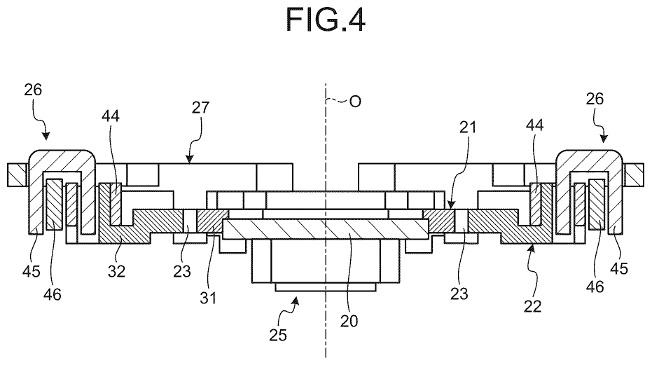

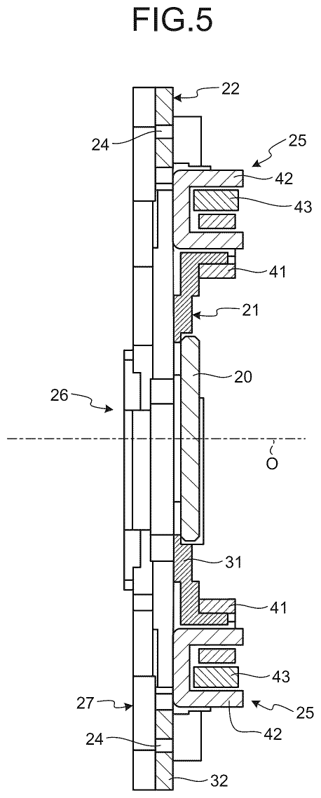

FIG. 3 is a plan view illustrating an optical path control mechanism, FIG. 4 is a sectional view taken on a line IV-IV in FIG. 3, and FIG. 5 is a sectional view taken on a line V-V in FIG. 3.

As illustrated in FIG. 3 to FIG. 5, the optical path control mechanism 12 has the swinging unit 12A including an optical member (optical unit) 20 where the light L is input, and the actuator 12B that swings the swinging unit 12A.

The actuator 12B swings the swinging unit 12A about a first swinging axis AX and a second swinging axis BX that are along two directions intersecting (and preferably orthogonal to) each other, with respect to the direction of incidence of the light L on the optical member 20. The first swinging axis AX and the second swinging axis BX are preferably orthogonal to each other. Therefore, the optical path control mechanism 12 has a first swinging portion 21 and a second swinging portion 22 that serve as the swinging unit 12A, first axis portions 12 and second axis portions 24 that are along the first swinging axis AX and the second swinging axis BX, a first actuator 25 and a second actuator 26 that serve as the actuator 12B, and a support portion 27.

The optical member 20 is a member that transmits the light L incident thereon. The light L is input to the optical member 20 from one of surfaces of the optical member 20, the optical member 20 transmits the light L input to the optical member 20, and outputs the light L from the other one of the surfaces. The optical member 20 is a glass plate, but may be made of any material and may have any shape.

The first swinging portion 21 has the optical member 20 and a first movable portion 31. The first movable portion 31 is a member that supports the optical member 20. The first movable portion 31 is fixed to the optical member 20. Specifically, the first movable portion 31 is a member having a frame shape of a plate having a through hole 31a formed at the center of the plate. The optical member 20 is fixed to the first movable portion 31 in a state of having been fitted in the through hole 31a of the first movable portion 31. The optical member 20 is fixed to the first movable portion 31 via a fixing member or an adhesive for the optical member 20 to be fixed to the first movable portion 31, but any method of fixing the optical member 20 to the first movable portion 31 may be adopted.

The second swinging portion 22 is arranged outside the first swinging portion 21. The second swinging portion 22 has a second movable portion 32. The second movable portion 32 is a member that supports the first movable portion 31. The first movable portion 31 is supported by the second movable portion 32 such that the first movable portion 31 is swingable about the first swinging axis AX. Specifically, the second movable portion 32 is a member having a frame shape of a plate having a through hole 32a formed at the center of the plate. The first movable portion 31 is swingably supported by the second movable portion 32 in a state of being arranged in the through hole 32a of the second movable portion 32 with a predetermined space therefrom. The first movable portion 31 and the second movable portion 32 are connected to each other by the pair of first axis portions 23 that are along the first swinging axis AX. The first movable portion 31 swings about the first swinging axis AX by being elastically deformed such that that the pair of second axis portions 24 are twisted with respect to the second movable portion 32.

The support portion 27 is arranged outside the second swinging portion 22. The support portion 27 is a member that supports the second movable portion 32. The second movable portion 32 is supported by the support portion 27 such that the second movable portion 32 is swingable about the second swinging axis BX. Specifically, the support portion 27 is a member having a frame shape of a plate having a through hole 27a formed at the center of the plate. The second movable portion 32 is swingably supported by the support portion 27 in a state of being arranged in the through hole 27a of the support portion 27 with a predetermined space therefrom. The second movable portion 32 and the support portion 27 are connected to each other by the pair of second axis portions 24 that are along the second swinging axis BX. The second movable portion 32 swings about the second swinging axis BX by being elastically deformed such that that the pair of the second axis portions 24 are twisted with respect to the support portion 27.

The second movable portion 32 (second swinging portion 22) swings about the second swinging axis BX with respect to the support portion 27, with the pair of second axis portions 24 being the fulcra. The first movable portion 31 (first swinging portion 21) swings about the first swinging axis AX with respect to the second movable portion 32, with the pair of first axis portions 23 being the fulcra. Therefore, the optical member 20 that has been fixed to the second movable portion 32 is capable of swinging about the first swinging axis AX and the second swinging axis BX. The optical member 20 swinging about the first swinging axis AX and the second swinging axis BX changes the posture of the optical member 20 and enables the optical path of the light L transmitted through the optical member 20 to be shifted.

The first movable portion 31, the second movable portion 32, the first axis portions 23, and the second axis portions 24 are integrally formed in this embodiment. The first movable portion 31 thus swings with respect to the second movable portion 32 by being elastically deformed such that that the first axis portions 23 are twisted in a circumferential direction. However, the first movable portion 31, the second movable portion 32, and the first axis portions 23 may be separately formed and connected to each other. One end portion and the other end portion of the second movable portion 32 are fixed to the support portion 27 so as to be connected to the support portion 27, and the second axis portions 24 are respectively formed at end portions of the second movable portion 32, the one end portion and the other end portion being along the second swinging axis BX. However, the second axis portions 24 may be respectively provided at the end portions of the second movable portion 32, and the second axis portions 24 may be fixed to the support portion 27 so as to be directly connected to the support portion 27. Furthermore, the second movable portion 32, the second axis portions 24, and the support portion 27 may be integrally formed.

The first actuator 25 swings the first movable portion 31 about the first swinging axis AX with respect to the support portion 27, with the pair of first axis portions 23 being the fulcra. The first actuator 25 is arranged on both one side and the other side of the first swinging axis AX in radial directions (along the second swinging axis BX). The first actuator 25 has a coil 41, a yoke 42, and a magnet 43.

The coil 41 has been attached to the first movable portion 31 and is fixed to a coil attachment portion 31b provided in the first movable portion 31. The coil 41 is provided at each of two end portions of the first movable portion 31, the two end portions being in radial directions from the first swinging axis AX (at one end and the other end along the second swinging axis BX). The yoke 42 is a member that forms a magnetic path. The yoke 42 has been attached to the support portion 27 and is fixed to the support portion 27. The yoke 42 is arranged at the two end portions of the first movable portion 31, correspondingly to the coil 41. The magnet 43 is a permanent magnet. The magnet 43 has been attached to the yoke 42 and is fixed to the yoke 42. The magnet 43 is arranged at positions that are each adjacent to the coil 41.

A driving signal from the driving circuit 16 (see FIG. 2) is input to the coil 41. In an example illustrated in FIG. 5, the magnet 43 is adhered to one side of the yoke 42 having a U shape, and an air gap is formed between a surface of the magnet 43 and a surface of the yoke 42, the surface of the magnet 43 not having been adhered to the yoke 42, the surface of the yoke 42 being opposite to the surface of the magnet 43 and forming the U shape. The coil 41 is arranged in the air gap. When a driving signal is input to the coil 41, electric current flows through and the coil 41, which is an electric conductor in the air gap (magnetic field) formed by the magnet 43 and the yoke 42, force is thereby generated in the coil 41, and this force swings the first movable portion 31 (first swinging portion 21) that has been fixed to the coil 41. That is, the first actuator 25 may be said to be an electromagnetic actuator including the coil 41, the yoke 42, and the magnet 43.

The second actuator 26 swings the second movable portion 32 (second swinging portion 22) about the second swinging axis BX with respect to the support portion 27, with the pair of second axis portions 24 being the fulcra. The second actuator 26 is arranged on both one side and the other side of the second swinging axis BX in radial directions (along the first swinging axis AX). The second actuator 26 has a coil 44, a yoke 45, and a magnet 46.

The coil 44 has been attached to the second movable portion 32 and is fixed to a coil attachment portion 32b provided in the second movable portion 32. The coil 44 is provided at each of two end portions of the second movable portion 32, the two end portions being in radial directions from the second swinging axis BX (at one end and the other end along the first swinging axis AX). The yoke 45 is a member that forms a magnetic path. The yoke 45 has been attached to the support portion 27 and is fixed to the support portion 27. The yoke 45 is arranged at the two end portions of the second movable portion 32, correspondingly to the coil 44. The magnet 46 is a permanent magnet. The magnet 46 has been attached to the yoke 45 and is fixed to the yoke 45. The magnet 46 is arranged at positions that are each adjacent to the coil 44.

A driving signal from the driving circuit 16 (see FIG. 2) is input to the coil 44. In the example illustrated in FIG. 4, the magnet 46 is adhered to one side of the yoke 45 having a U shape, and an air gap is formed between a surface of the magnet 46 and a surface of the yoke 45, the surface of the magnet 46 not having been adhered to the yoke 45, the surface of the yoke 45 being opposite to the surface of the magnet 46 and forming the U shape. The coil 44 is arranged in the air gap. When a driving signal is input to the coil 44, electric current flows through the coil 44, which is an electric conductor in the air gap (magnetic field) formed by the magnet 46 and the yoke 45, force is thereby generated in the coil 44, and this force swings the second movable portion 32 (second swinging portion 22) that has been fixed to the coil 44. That is, the second actuator 26 may be said to be an electromagnetic actuator including the coil 44, the yoke 45, and the magnet 46.

In the optical path control mechanism 12, the first movable portion 31 provided with the optical member 20 swings and the second movable portion 32 that supports the first movable portion 31 swings, and the optical member 20, the first movable portion 31, the second movable portion 32, and the coils 41 and 44 may thus be said to be included in the swinging unit 12A. That is, part of the optical path control mechanism 12 may be said to be referred to as the swinging unit 12A, the part being part that swings with respect to the support portion 27. The first axis portions 23 also swing with the second movable portion 32 and are thus also included in the swinging unit 12A. In a case where the fixing member or adhesive for fixing the optical member 20 to the first movable portion 31, or a board and lead wires for flow of the electric current through the coils 41 and 44 have been provided, these also swing with respect to the support portion 27 and are thus also included in the swinging unit 12A.

In this embodiment, the first movable portion 31 is swung by the first actuator 25 and the second movable portion 32 is swung by the second actuator 26. In this case, the yokes 42 and 45 respectively included in the first and second actuators 25 and 26 have been fixed to the support portion 27. Therefore, to prevent the first actuator 25 and the second movable portion 32 from interfering with each other when the second movable portion 32 is swung by the second actuator 26, a gap has been formed therebetween. The first actuator 25 may be provided in the second movable portion 32.

The first and second actuators 25 and 26 are of the so-called moving coil type having the coils 41 and 44 arranged in the movable portions 31 and 32, but without being limited to the moving coil type, the first and second actuators 25 and 26 may be of, for example, the so-called moving magnet type having the magnets 43 and 46 arranged in the movable portions 31 and 32 and the coils 41 and 44 arranged in the support portion 27. In this case, the magnets 43 and 46 are swung together with the optical member 20 and the magnets 43 and 46 are thus included in the swinging unit 12A, instead of the coils 41 and 44.

The optical path control mechanism 12 has the above described configuration, but without being limited to this configuration, the optical path control mechanism 12 may have any configuration enabling the optical path of the light L to be shifted by an optical unit by the optical unit being swung by an actuator where a driving signal is applied.

### Driving Signal

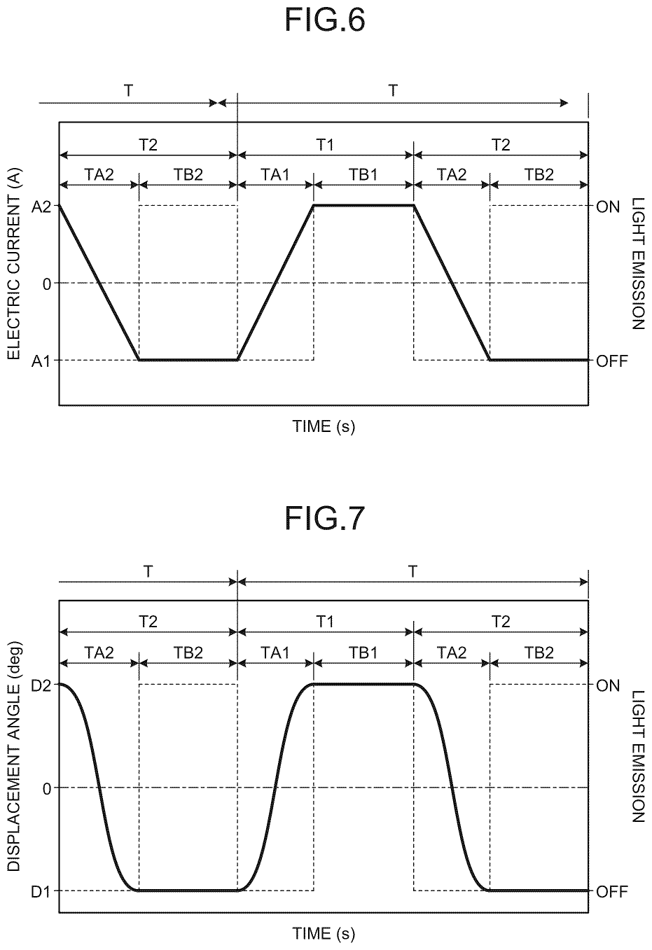

The following description is on a driving signal applied by the driving circuit 16 to the actuator 12B. FIG. 6 is a graph illustrating a waveform of a driving signal of a driving unit.

As illustrated in FIG. 6, a driving signal applied to the first actuator 25 by the driving circuit 16 is an electric signal and the current value of the driving signal changes as time elapses. A waveform representing the change in the electric current value of the driving signal over time will hereinafter be referred to as the waveform of the driving signal. The waveform of the driving signal is represented by a solid line in FIG. 6. The driving signal has the same waveform repeated every period T. The period T includes a time period T1, and a time period T2 after the time period T1 and consecutive to the time period T1. The time period T1 corresponds to a time period, in which an image (an image not shifted by half a pixel) is displayed, the image being of a time when the optical axis of the light L is at a first position, and the time period T2 corresponds to a time period, in which an image (an image shifted by half a pixel) is displayed, the image being of a time when the optical axis of the light L is at a second position.

The electric current value of the driving signal changes from a first current value A1 to a second current value A2 in a first time period TA1 of the time period T1. An intermediate position 0 between the first current value A1 and the second current value A2 is a position where the electric current value is 0. The electric current value of the driving signal changes linearly from the first current value A1 to the second current value A2 in the first time period TA1 as time elapses. That is, at the start of the first time period TA1, the electric current value of the driving signal is the first current value A1, the electric current value of the driving signal thereafter changes linearly from the first current value A1, and the electric current value of the driving signal then reaches the second current value A2 at the end of the first time period TA1. The first current value A1 is an electric current value that enables the first swinging portion 21 to be held at a first angle D1 and is set according to a numerical value of the first angle D1. The second current value A2 is an electric current value that enables the first swinging portion 21 to be held at a second angle D2 and is set according to a numerical value of the second angle D2. The first current value A1 and the second current value A2 are oppositely negative and positive electric current values and may have absolute values equal to each other. FIG. 6 illustrates an example where the first current value A1 is negative and the second current value A2 is positive.

The first time period TA1 has a length of a value corresponding to a natural frequency of the first swinging portion 21. The first swinging portion 21 is a portion (the optical member 20, the first movable portion 31, and the coil 41 in this embodiment) of the optical path control mechanism 12, the portion being a portion that swings with respect to the support portion 27. That is, the length of the first time period TA1 may be said to be of a value corresponding to a natural frequency of the portion that swings with respect to the support portion 27. More particularly, the length of the first time period TA1 is preferably of approximately the same value as a natural period of the first swinging portion 21 and more preferably of the same value as the natural period. The natural period is a reciprocal of the natural frequency. “Being of approximately the same value” means that a value with a difference within an error range from the natural period is also allowed. For example, in a case where the difference from the natural period is 5% or less of the value of the natural period, the value may also be regarded as “being of approximately the same value”. The phrase, “being of approximately the same value”, will also have a similar meaning hereinafter. The value of the natural period (the reciprocal of the natural frequency) is expressed as “1/f” seconds in a case where the natural frequency is f Hz.

The electric current value of the driving signal is held at the second current value A2 in the second time period TB1 of the time period T1. The second time period TB1 is a time period after the first time period TA1 and consecutive to the first time period TA1. The natural frequency of the first swinging portion 21 is preferably large because increasing the natural frequency of the first swinging portion 21 enables the first time period TA1 to be shortened and the second time period TB1 to be lengthened (for example, to be made longer than the first time period TA1). Being held at the second current value A2 is not limited to the electric current value strictly not changing from the second current value A2 and may include the electric current value changing from the second current value A2 in a range of a predetermined value. This predetermined value may be set optionally, and may be, for example, a value that is 10% of the second current value A2.

In the time period T1, the electric current value of the driving signal thus gradually changes from the first current value A1 to the second current value A2 and is held at the second current value A2 after reaching the second current value A2.

The electric current value of the driving signal changes from the second current value A2 to the first current value A1 in a third time period TA2 of the time period T2. The third time period TA2 may be said to be a time period after the second time period TB1 and consecutive to the second time period TB1. Furthermore, the electric current value of the driving signal changes linearly from the second current value A2 to the first current value A1 as time elapses in the third time period TA2. That is, the electric current value of the driving signal is at the second current value A3 at the start of the third time period TA2, linearly changes thereafter from the second current value A2, and reaches the first current value A1 at the end of the third time period TA2.

The third time period TA2 has a length of a value corresponding to the natural frequency of the first swinging portion 21. More particularly, the length of the third time period TA2 is preferably of approximately the same value as the natural period (the reciprocal of the natural frequency) of the first swinging portion 21 and more preferably of the same value as the natural period. The length of the third time period TA2 is equal to the length of the first time period TA1.

The electric current value of the driving signal is held at the first current value A1 in a fourth time period TB2 of the time period T2. The fourth time period TB2 is a time period after the third time period TA2 and consecutive to the third time period TA2. Furthermore, the fourth time period TB2 is a time period before a first time period TA1 and consecutive to the first time period TA1. The length of the fourth time period TB2 is equal to the length of the second time period TB1. The natural frequency of the first swinging portion 21 is preferably large because increasing the natural frequency of the first swinging portion 21 enables the third time period TA2 to be shortened and the fourth time period TB2 to be lengthened (for example, to be made longer than the third time period TA2). Being held at the first current value A1 is not limited to the electric current value strictly not changing from the first current value A1 and may include the electric current value changing from the first current value A1 in a range of a predetermined value. This predetermined value may be set optionally, and may be, for example, a value that is 10% of the first current value A1.

In the time period T2, the electric current value of the driving signal thus gradually changes from the second current value A2 to the first current value A1 and is held at the first current value A1 after reaching the first current value A1.

As described above, in this embodiment, the waveform of the driving signal is trapezoidal, and the lengths of the first time period TAL and the third time period TA2, both in which the electric current value changes, are of values corresponding to a natural frequency of the swinging unit 12A.

A broken line illustrated in FIG. 6 represents a time period, in which the light L is emitted. Preferably, the irradiation device 100 does not emit the light L in the first time period TA1 and emits the light L in the second time period TB1. Furthermore, preferably, the irradiation device 100 does not emit the light L in the third time period TA2 and emits the light L in the fourth time period TB2.

### Swinging Pattern

A swinging pattern of the first swinging portion 21 resulting from application of a driving signal will be described next. FIG. 7 is a graph illustrating a monoaxial swinging pattern of an optical unit.

As illustrated in FIG. 7, the swinging pattern of the first swinging portion 21 refers to the displacement angle (the angle about the first swinging axis AX) of the first swinging portion 21 over time upon application of a driving signal to the first actuator 25. The swinging pattern is represented by a solid line in FIG. 7.

The electric current value of the driving signal changes from the first current value A1 to the second current value A2 in the first time period TA1. The displacement angle of the first swinging portion 21 thereby changes from a first angle D1 to a second angle D2 in the first time period TA1. An intermediate position 0 between the first angle D1 and the second angle D2 is a position where the displacement angle of the first swinging portion 21 is 0.

The electric current value of the driving signal is held at the second current value A2 in the second time period TB1. The displacement angle of the first swinging portion 21 is thereby held at the second angle D2 in the second time period TB1. Being held at the second angle D2 is not limited to the displacement angle strictly not changing from the second angle D2 and may include the displacement angle changing from the second angle D2 in a range of a predetermined value. This predetermined value may be set optionally, and may be, for example, a value that is 10% of the second angle D2.

The electric current value of the driving signal changes from the second current value A2 to the first current value A1 in the third time period TA2. The displacement angle of the first swinging portion 21 thereby changes from the second angle D2 to the first angle D1 in the third time period TA2.

The electric current value of the driving signal is held at the first current value A1 in the fourth time period TB2. The displacement angle of the first swinging portion 21 is thereby held at the first angle D1 in the fourth time period TB2. Being held at the first angle D1 is not limited to the displacement angle strictly not changing from the first angle D1 and may include the displacement angle changing from the first angle D1 in a range of a predetermined value. This predetermined value may be set optionally, and may be, for example, a value that is 10% of the first angle D1.

The light L is emitted during the second time period TB1 and the fourth time period TB2. Therefore, in the second time period TB1, the first swinging portion 21 held at the second angle D2 is irradiated with the light L and the optical path of the light L is at the first position. In the fourth time period TB2, the first swinging portion 21 held at the first angle D1 is irradiated with the light L, the optical path of the light L is shifted to the second position, and the image is shifted by half a pixel.

The optical path control device 10 that shifts the optical path by swinging the optical member 20 desirably swings the optical member 20 stably. In this embodiment, the lengths of the first time period TA1 and the third time period TA2 are set to the values corresponding to the natural frequency of the first swinging portion 21, and vibration of the first swinging portion 21 is thereby able to be minimized in the second time period TB1 and the fourth time period TB2 and the first swinging portion 21 is thus able to be swung stably. That is, the lengths of the first time period TA1 and the third time period TA2 are at the values corresponding to the natural frequency of the first swinging portion 21, and the vibration of the first swinging portion 21 in the second time period TB1 and the fourth time period TB2 is thereby able to be minimized and the first swinging portion 21 is thus able to be swung stably. Therefore, the first swinging portion 21 is able to be swung at high speed and caused to be stationary stably, and degradation of the image is thus able to be minimized.

The driving signal applied to the first actuator 25 has been described herein as the driving signal to be applied by the driving circuit 16 to the actuator 12B. A similar description applies to a driving signal to be applied to the second actuator 26 and description thereof will thus be omitted.

### Operation of Pixels by Optical Path Control Mechanism

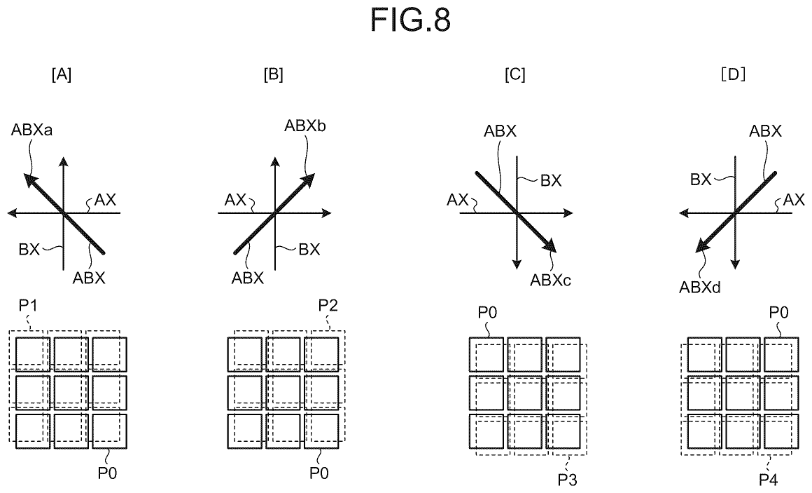

Operation upon swinging of the first swinging portion 21 and the second swinging portion 22 will be described hereinafter. FIG. 8 is a diagram illustrating a biaxial swinging pattern of the optical unit.

According to the driving signal, the first actuator 25 and the second actuator 26 included in the actuator 12B in the optical path control mechanism 12 of this embodiment respectively swing the first swinging portion 21 and the second swinging portion 22 such that a change in posture from the first angle D1 to the second angle D2 and a change in posture from the second angle D2 to the first angle D1 about the first swinging axis AX and the second swinging axis BX are repeated. According to a combination thereof, shifts of the optical axis of the light L from the first position to the second position, from the second position to a third position, from a third position to a fourth position, and from the fourth position to the first position are repeated.

That is, an image projected onto a screen by the light L when the optical axis is at the first position and an image projected onto the screen by the light L when the optical axis is at the second position are shifted from each other by half a pixel, and an image projected onto the screen by the light L when the optical axis is at the third position and an image projected onto the screen by the light L when the optical axis is at the fourth position are similarly shifted from each other by half a pixel. That is, an image projected onto the screen is always displayed so as to be shifted upward, downward, leftward, rightward, or diagonally by half a pixel. The apparent number of pixels is thereby increased, and resolution of images projected onto the screen are able to be increased. The amount of shift of the optical axis is half a pixel of an image, and the first angle D1 and the second angle D2 are thus set at angles that enable the image to be shifted by half a pixel. The amount of shift of an image is not limited to half a pixel, and any amount, such as ¼ or ⅛ pixel, may be adopted, for example. The first angle D1 and the second angle D2 may be set as appropriate according to the amount of the shift of an image.

A specific description will be made hereinafter. The direction of the first swinging axis AX and the direction of the second swinging axis BX intersect each other orthogonally and are parallel to the direction in which the pixels are arranged. As illustrated in FIG. 8, an image position P0 is a display position for when the electric current value to be applied to the first actuator 25 and the second actuator 26 is 0, that is, when the displacement angle of the optical member 20 is 0. An operation state A is a state where the optical member 20 has been swung by the first actuator 25 about the first swinging axis AX by a predetermined angle, the image position P0 has been shifted along the second swinging axis BX by ¼ pixel, the optical member 20 has been swung by the second actuator 26 about the second swinging axis BX by a predetermined angle, and the image position P0 has been shifted along the first swinging axis AX by ¼ pixel. That is, the operation state A is a state where an image is displayed at an image position P1 shifted from the image position P0 in one direction ABXa along an ABX direction resulting from combination of a vector directed in one direction along the first swinging axis AX and a vector directed in one direction along the second swinging axis BX.

Similarly, an operation state B is a state where an image is displayed at an image position P2 shifted from the image position P0 in one direction ABXb along an ABX direction resulting from combination of a vector directed in one direction along the first swinging axis AX and a vector directed in one direction along the second swinging axis BX. Similarly, an operation state C is a state where an image is displayed at an image position P3 shifted from the image position P0 in one direction ABXc along an ABX direction resulting from combination of a vector directed in one direction along the first swinging axis AX and a vector directed in one direction along the second swinging axis BX. Similarly, an operation state D is a state where an image is displayed at an image position P4 shifted from the image position P0 in one direction ABXd along an ABX direction resulting from combination of a vector directed in one direction along the first swinging axis AX and a vector directed in one direction along the second swinging axis BX.

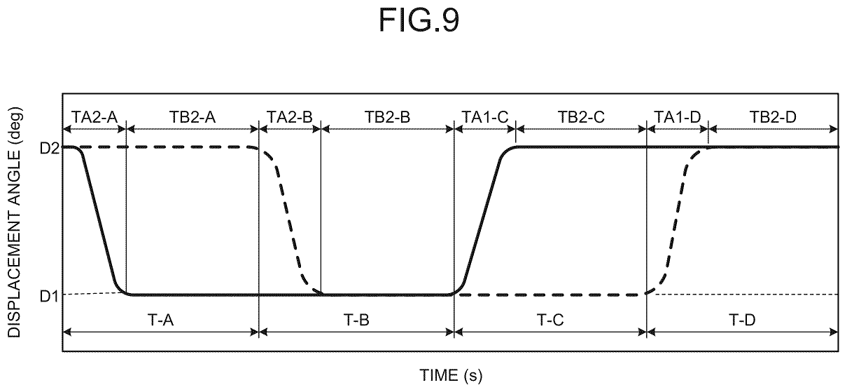

The following description is on swinging patterns of the first swinging portion 21 and the second swinging portion 22 in the above mentioned operation states of pixels. FIG. 9 is a graph illustrating the biaxial swinging pattern of the optical unit.

In the following description, the swinging pattern of the first swinging portion 21 refers to the displacement angle (the angle about the first swinging axis AX) of the first swinging portion 21 over time when a driving signal is applied to the first actuator 25 and this swinging pattern is represented by a solid line. The swinging pattern of the second swinging portion 22 refers to the displacement angle (the angle about the second swinging axis BX) of the second swinging portion 22 over time when a driving signal is applied to the second actuator 26, and this swinging pattern is represented by a broken line.

As illustrated in FIG. 9, in a displacement time period TA2-A, the electric current value of the driving signal applied to the first actuator 25 changes from the second current value A2 to the first current value A1 (see FIG. 6). The displacement angle of the first swinging portion 21 thereby changes from the second angle D2 to the first angle D1 in the displacement time period TA2-A. In a displacement time period TA2-B, the electric current value of the driving signal applied to the second actuator 26 changes from the second current value A2 to the first current value A1. The displacement angle of the second swinging portion 22 thereby changes from the second angle D2 to the first angle D1 in the displacement time period TA2-B.

The electric current value of the driving signal applied to the first actuator 25 changes from the first current value A1 to the second current value A2 in the displacement time period TA1-C. The displacement angle of the first swinging portion 21 thereby changes from the first angle D1 to the second angle D2 in the displacement time period TA1-C. The electric current value of the driving signal applied to the second actuator 26 changes from the first current value A1 to the second current value A2 in the displacement time period TA1-D. The displacement angle of the second swinging portion 22 thereby changes from the first angle D1 to the second angle D2 in the displacement time period TA1-D.

The displacement time period TA2-A, the displacement time period TA2-B, the displacement time period TA1-C, and the displacement time period TA1-D respectively represent time periods for transition to the operation state A, the operation state B, the operation state C, and the operation state D described above by reference to FIG. 8. In a case where the natural frequencies of the first swinging portion 21 and the second swinging portion 22 are the same, for example, lengths of the displacement time period TA2-A and the displacement time period TA2-B will be the same, lengths of a display time period TB2-A and a display time period TB2-B for when the electric current is maintained will thus be the same, how the images appear in the operation state A and the operation state B will thus be the same, and degradation of image quality will thus be minimized.

An example of the driving signal applied to the actuators and the swinging patterns of the swinging unit 12A according to the driving signal has been described above with respect to this embodiment, but any driving signal and swinging patterns may be adopted without being limited to the example.

### Frame Division Configuration

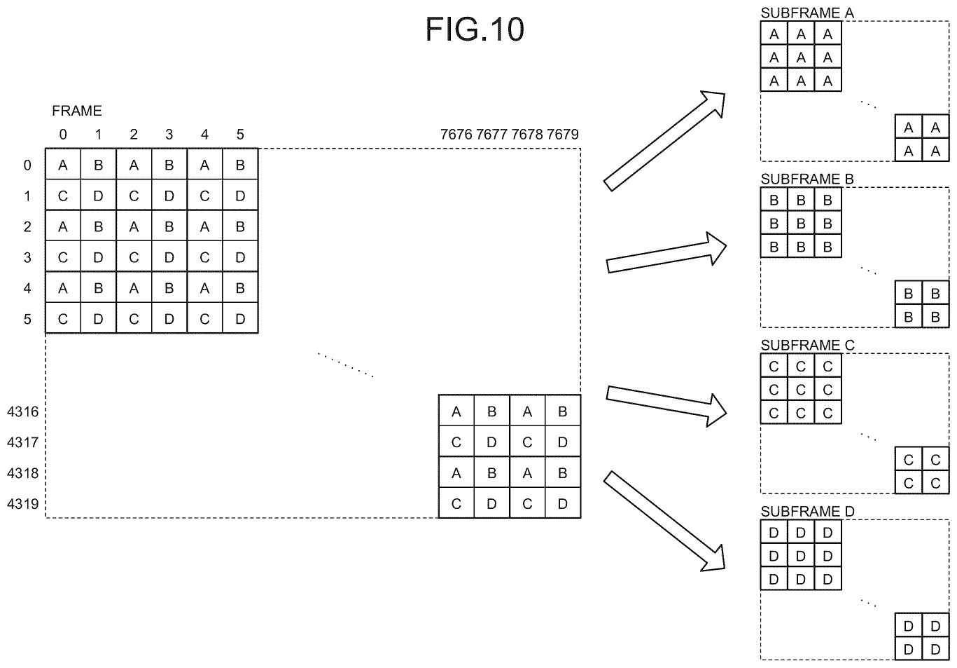

FIG. 10 is a diagram illustrating a frame division configuration by a processing unit. In this embodiment, a display time period for one frame is divided into display time periods of plural subframes, and the plural subframes are displayed in the display time period for the one frame. Resolution of the display device is thereby artificially increased. For example, a display device having 4K resolution is thereby caused to display image data having 8K resolution. The division into the subframes will hereinafter be described with respect to an example of a case where a display device having 4K resolution is caused to display image data having 8K resolution.

The subframes are divided frames each including some of pixels included in the one frame. In other words, the subframes are divided frames for displaying image data on some pixels, the image data being among image data on the pixels displayed in the display time period of the one frame. The pixels included in the respective subframes of the one frame do not overlap one another and the subframes in the one frame include pixels that are different from one another. In other words, the subframes are for display of mutually different sets of image data on pixels. In an example illustrated in FIG. 10, one frame of image data having 8K resolution includes plural combinations of four pixels A, B, C, and D, the plural combinations being arranged in columns and rows. Subframes each include image data to be displayed on the display device having 4K resolution. The plural pixels A, B, C, and D included in the one frame are divided into four subframes A, B, C, and D. In this case, the subframe A has only the plural pixels A included in and extracted from the one frame. The subframe A is for displaying only the one pixel A at the positions of the four pixels A, B, C, and D of the frame. Similarly, the subframe B has only the plural pixels B included in and extracted from the one frame. The subframe C has only the plural pixels C included in and extracted from the one frame. The subframe D has only the plural pixels D included in and extracted from the one frame. The image data on the frame having 8K resolution are thus displayed as the image data on the subframes having 4K resolution.

In this embodiment, the control unit 170 sets subframes for each frame and controls the display elements 106 by means of the video signal processing circuit 160 such that image data included in the subframes set for each frame are displayed in a time period for display of that frame. That is, in this embodiment, a display time period for one frame is divided into display time periods of plural subframes, and the plural subframes are displayed in the display time period for the one frame. In a case where a moving image is displayed by a method of dividing into subframes as described above, there is also a demand for adequately displaying the moving image with adequate gradation maintained. To address this demand, in this embodiment, setting the number of subframes in one frame on the basis of a motion vector V in a moving area included in an image to be displayed enables adequate display of a moving image with adequate gradation maintained. A specific description will be made hereinafter.

### Display Method for Subframes

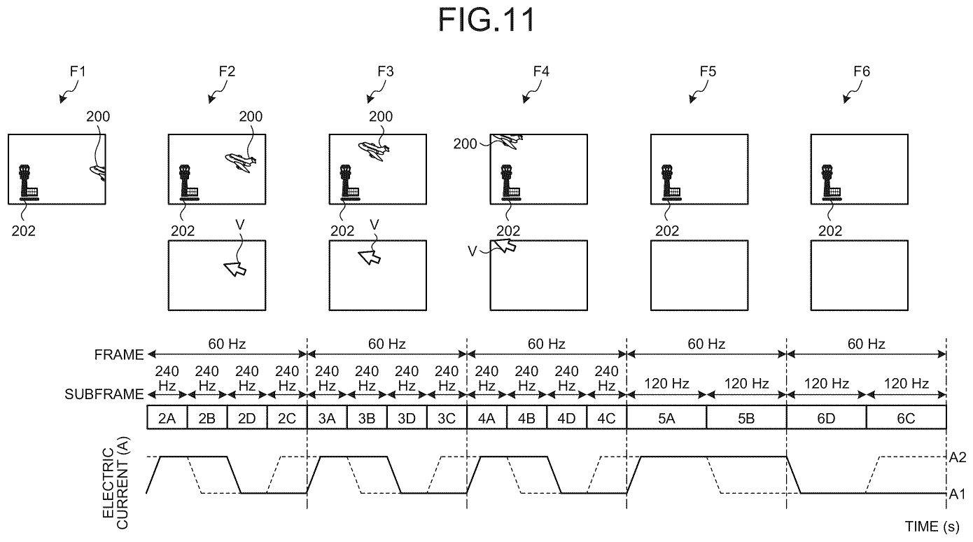

FIG. 11 is a diagram for description of an example of a display method for subframes according to the first embodiment. FIG. 11 illustrates, as an example of a moving image, an image group representing a state from a frame F1 to a frame F4, the state being where a target 200 (an airplane) passes through a space where a target 202 (a building) is captured, and a state from a frame F5 to a frame F6, the state being where the target 200 has passed through the space. In this example, targets to be used in determination of target areas are the targets 200 and 202, such as an airplane and a building, but the targets are not limited to this example and any targets may be adopted. In this embodiment, the targets are targets that can move or change in shape and have been subjected to learning beforehand. Data on the targets have been stored in the storage unit that the control unit 170 has.

Upon setting subframes, the control unit 170 obtains image data included in a frame. Specifically, if a frame to be displayed is referred to as a second frame and a frame displayed chronologically before the second frame is referred to as a first frame, the control unit 170 obtains image data included in the first frame (image data on each pixel displayed in a display time period for the first frame) and image data included in the second frame (image data on each pixel displayed in a display time period of the second frame). The first frame is a frame that is immediately before the second frame chronologically, but without being limited to this frame, the first frame may be a frame displayed at any time before the second frame (for example, a frame that is earlier than the second frame by plural frames). Furthermore, plural frames that are before the second frame may be referred to as first frames. In the example illustrated in FIG. 11, in a case where a frame F2 is the target to be displayed (the second frame), the control unit 170 obtains image data on the frame F2 and image data on a frame F1 that is immediately before the frame F2.

The control unit 170 extracts a target area from the image data in the first frame and the image data in the second frame and obtains a motion vector from the target area in the first frame and the target area in the second frame. Any method of extracting the target area and any method of obtaining the motion vector may be adopted, but in this embodiment, the control unit 170 compares images of the first frame and the second frame with each other and calculates the target area and the motion vector of the target area. The control unit 170 may calculate the target area and the motion vector by any method based on the image data on the first frame and the image data on the second frame and may use any publicly known technique. An example of a method of calculating the target area and the motion vector will be described hereinafter. The control unit 170 extracts a target area representing a common target, from the image data in the first frame and the image data in the second frame. The target area refers to an area where the same target has been captured in the image of the first frame and the image of the second frame. That is, the target area in the image of the first frame refers to an area (a pixel group) of the image of the first frame, the area being where a target that is also included in the image of the second frame has been captured, and the target area in the image of the second frame refers to an area (a pixel group) of the image of the second frame, the area being where the target that is also included in the image of the first frame has been captured. In the example illustrated in FIG. 11, the targets 200 and 202 are included in both of the image of the frame F1 and the image of the frame F2. Therefore, in the example illustrated in FIG. 11, the control unit 170 extracts a target area for the target 200 in the frame F1, the target area being an area (a pixel group) from the image data on the frame F1, the area including the target 200, and extracts a target area for the target 200 in the frame F2, the target area being an area (a pixel group) from the image data on the frame F2, the area including the target 200. Similarly, in the example illustrated in FIG. 11, the control unit 170 extracts a target area for the target 202 in the frame F1, the target area being an area (a pixel group) from the image data on the frame F1, the area including the target 202, and extracts a target area for the target 202 in the frame F2, the target area being an area (a pixel group) from the image data on the frame F2, the area including the target 202. Any method of extracting a target area from each set of image data may be adopted, and for example, a known image matching technique for extracting the same target from plural images may be used. In a case where the whole angle of view has moved between divided frames compared to each other, the whole angle of view is extracted as a target area.

After comparing the first frame and the second frame to each other and extracting the target area, the control unit 170 calculates a motion vector V of the target area on the basis of the target area in the first frame and the target area in the second frame. The target area where the motion vector V is generated in this embodiment is treated as a moving area that is an area where the motion vector V (an amount of movement) is generated. The motion vector V is an index indicating the amount of movement (the amount of movement of the moving area) of the moving area in the time period from the first frame to the second frame. The control unit 170 calculates the motion vector V of the target area (the moving area) from the position of the target area in the image of the first frame and the position of the target area in the image of the second frame. That is, for example, the control unit 170 calculates, as the amount of movement (the motion vector) of a target area (a moving area), a difference between the position of the target area in the image of the first frame and the position of the target area in the image of the second frame, the positions being in a coordinate system based on the images. In a case where there are plural target areas (moving areas), the control unit 170 calculates a motion vector V for each of the target areas (moving areas). In the example illustrated in FIG. 11, the control unit 170 calculates a motion vector V of the moving area for the target 200, on the basis of the positions of the target 200 in the first frame and the second frame. Similarly, the control unit 170 calculates a motion vector V of the moving area for the target 202, on the basis of the positions of the target 202 in the first frame and the second frame. The control unit 170 may calculate, as a motion vector, the direction of movement of a moving area, in addition to the amount of movement of the moving area. That is, a motion vector V may refer to only the amount of movement of a moving area, or may refer to both the amount of movement of the moving area and the direction of the movement (movement direction). The movement direction is able to be calculated from the position of the moving area in the image in the first frame and the position of the moving area in the image of the second frame, the positions being in the coordinate system based on the images.

On the basis of the calculated motion vector V of the moving area, the control unit 170 sets the number of subframes for the second frame. That is, the control unit 170 sets the number of subframes for the second frame, on the basis of the motion vector (amount of movement) V of the moving area in the time period from the first frame to the second frame. In this embodiment, the control unit 170 determines whether or not the motion vector (the amount of movement) V of the moving area is larger than a predetermined threshold. More specifically, the control unit 170 sets the number of subframes for the second frame larger in a case where the motion vector V is larger than the threshold, than the number of subframes for the second frame in a case where the motion vector V is equal to or less than the threshold. In other words, the control unit 170 sets, for displaying a moving image, the number of subframes for the second frame to a first predetermined number in the case where the motion vector V is larger than the threshold. In the case where the motion vector V is equal to or less than the threshold, the control unit 170 sets, for displaying a still image, the number of subframes for the second frame to a second predetermined number less than the first predetermined number. In a case where there are plural moving areas, the above described determination is performed by use of the largest one of motion vectors (amounts of movement) V of the respective moving areas. Any value may be set as the threshold. In the example illustrated in FIG. 11, in a case where the frame F2 is the target to be displayed (second frame), the motion vector V of the target 200 is larger than the threshold. Similarly, the motion vector V of the target 200 is also larger than the threshold for the frames F3 and F4. However, for the frames F5 and F6, the target 200 has not been captured therein, and the motion vector V of the target 202 that has been captured therein is equal to or less than the threshold. Therefore, in the example illustrated in FIG. 11, the number of subframes for the frames F2 to F4 is larger than the number of subframes for the frames F5 and F6.

Furthermore, in the case where the motion vector V is larger than the threshold, the control unit 170 preferably sets the subframes so that all of pixels included in the second frame are each included in one of the subframes. That is, in the example illustrated in FIG. 11, four subframes 2A, 2B, 2D, and 2C have been set for the frame F2, and of plural pixels A, B, C, and D included in the frame F2, the pixels A are included in the subframe 2A, the pixels B are included in the subframe B, the pixels C are included in the subframe 2C, and the pixels D are included in the subframe 2D. A similar description applies to the frames F3 and F4 and the description thereof will thus be omitted.

Furthermore, in the case where the motion vector V is equal to or less than the threshold, the control unit 170 preferably sets the subframes so that only some of the pixels included in the second frame are each included in one of the subframes. In this case, the control unit 170 also preferably sets subframes for a frame (third frame) succeeding the second frame so that pixels different from pixels not included in the subframes of the second frame are each included in one of the subframes. That is, in the example illustrated in FIG. 11, two subframes 5A and 5B have been set for the frame F5, and of plural pixels A, B, C, and D included in the frame F5, the pixels A are included in a subframe 5A, and the pixels B are included in the subframe 5B. Subframes 6D and 6C have been set for the frame F6, and of plural pixels A, B, C, and D included in the frame F5, the pixels D not included in the subframes 5A and 5B are included in the subframe 6D and the pixels C are included in the subframe 6C. Without being limited to being on the same line (horizontal arrangement), a combination of the pixel A and the pixel D, or a combination of the pixel B and the pixel C may be adopted.

In the example illustrated in FIG. 11, the number of subframes (the first predetermined number) is four in the case where the motion vector V is larger than the threshold and the number of subframes (the second predetermined number) is two in the case where the motion vector V is equal to less than the threshold, but the first predetermined number and the second predetermined number are not limited to this example, and may be any numbers. However, the first predetermined number and the second predetermined number are preferably set according to the number of swinging axes. Furthermore, in the example of this embodiment, the number of subframes is set to any one of the two types of numbers, the first predetermined number or the second predetermined number, but the number of subframes is not limited to this example. For example, the number of subframes to be set may be set to any one of any three or more types of numbers according to the motion vector V. In this case, preferably, the larger the motion vector (the amount of movement) V, the larger the number of subframes set by the control unit 170. For example, in a case where the motion vector V is equal to or less than a first threshold, the number of subframes may be set to one, in a case where the motion vector V is larger than the first threshold and equal to or less than a second threshold having a value higher than that of the first threshold, the number of subframes may be set to two, and in a case where the motion vector V is larger than the second threshold, the number of subframes may be set to four.

In the example of this embodiment, the threshold for the motion vector V is a fixed value that has been fixed for each frame and each moving area but without being limited to this example, the threshold may be set for each moving area. In this case, for example, the control unit 170 may set the threshold on the basis of the size of the moving area. More preferably, the larger the size of the moving area is, the smaller the threshold set by the control unit 170 may be. As a result, the larger the moving area, the larger the set number of subframes, even if the amount of movement is small.

After setting the number of subframes for the second frame, the control unit 170 sets, for each of the subframes set, pixels to be included in the subframe, that is, pixels for display of an image based on image data in a display time period of that subframe.

### Display of Image for Each Subframe

After setting the subframes for the second frame, the control unit 170 outputs information on the set subframes to the video signal processing circuit 160. The control unit 170 thereby causes the video signal processing circuit 160 to control the display elements 106 such that images of image data included in the subframes set for the second frame are displayed in the time period for display of the second frame. Furthermore, the control unit 170 causes the video signal processing circuit 160 to control the display elements 106 such that the subframes set for the second frame are successively displayed in the time period for the display of the second frame. The display of the image of each subframe will hereinafter be described in more detail.

### Image Display in Case Where Motion Vector is Larger Than Threshold

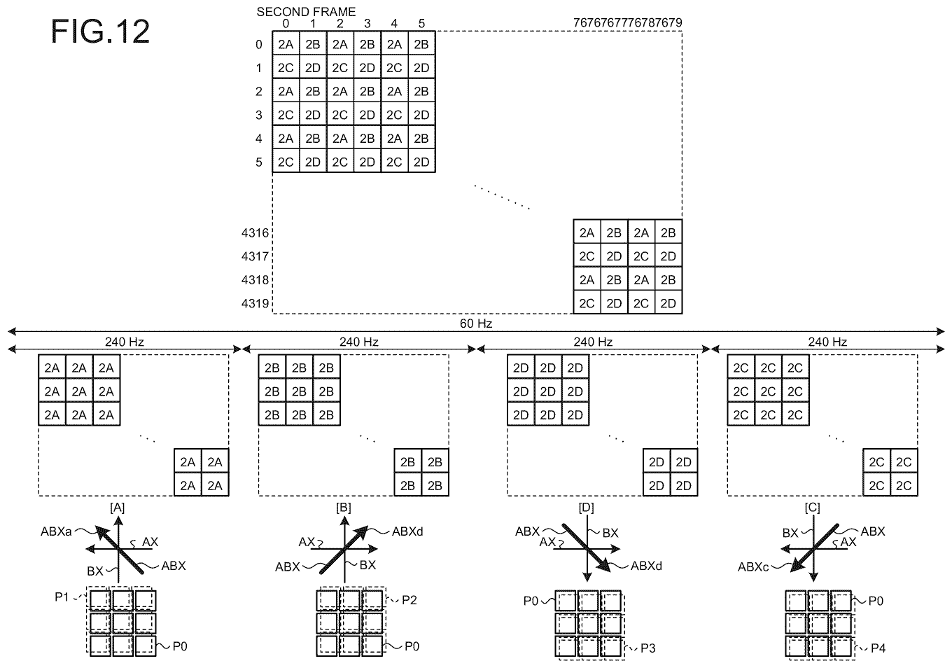

FIG. 12 is a schematic diagram illustrating an example of image display in a case where a motion vector is larger than a threshold. In this embodiment, in the case where the motion vector V is larger than the threshold, subframes for the second frame to be displayed are set so that all of the pixels included in the second frame are each included in one of the subframes. The video signal processing circuit 160 then controls the display elements 106R, 106G, and 106B such that the subframes set for the second frame are successively displayed in the time period for the display of the second frame. On the basis of a synchronization signal input from the video signal processing circuit 160, the control circuit 14 then generates a digital driving signal. On the basis of this driving signal, the driving circuit 16 drives the actuator 12B to swing the swinging unit 12A. A specific description will be made hereinafter.

In the example illustrated in FIG. 11 and FIG. 12, the video signal processing circuit 160 controls the display elements 106R, 106G, and 106B such that the four subframes 2A, 2B, 2D, and 2C resulting from the division are successively displayed in the time period (60 Hz) for the display of the second frame (the frame F2 herein). The time period for the display of each of the subframes 2A, 2B, 2D, and 2C is a time period (240 Hz) that is ¼ of the time period (60 Hz) for the display of the second frame.

In this control, as illustrated in FIG. 2, FIG. 11, and FIG. 12, the control circuit 14 generates a digital driving signal on the basis of a synchronization signal input from the video signal processing circuit 160 and the driving circuit 16 drives the actuators 25 and 26 on the basis of the driving signal. That is, as illustrated in FIG. 11, upon display of the subframe 2A, the driving circuit 16 applies the second current value A2 to the first actuator 25 and the second actuator 26. The second actuator 26 then swings the optical member 20 about the second swinging axis BX to achieve the operation state A where the image position P0 has been shifted along the first swinging axis AX by ½ pixel, as illustrated in FIG. 12. That is, an image is displayed at the image position P1 shifted from the image position P0 in the one direction ABXa along the ABX direction.

Thereafter, as illustrated in FIG. 11, upon display of the subframe 2B, the driving circuit 16 applies the first current value A1 to the second actuator 26, with the second current value A2 still being applied to the first actuator 25. The second actuator 26 then swings the optical member 20 about the second swinging axis BX to achieve the operation state B where the image position P1 has been shifted along the first swinging axis AX by ½ pixel from the image position P1, as illustrated in FIG. 12. That is, an image is displayed at the image position P2 shifted from the image position P0 in the one direction ABXb along the ABX direction.

Thereafter, as illustrated in FIG. 11, upon display of the subframe 2D, the driving circuit 16 changes the electric current value to the first current value A1 with the application of the second current value A2 to the first actuator 25 still being stopped, and keeps the first current value A1 being applied to the second actuator 26. The first actuator 25 then swings the optical member 20 (see FIG. 3) about the first swinging axis AX to shift the image position P2 along the second swinging axis BX by ½ pixel and achieve the operation state D, as illustrated in FIG. 12. That is, an image is displayed at the image position P3 shifted from the image position P0 in the one direction ABXd along the ABX direction.

Thereafter, as illustrated in FIG. 11, upon display of the subframe 2C, the driving circuit 16 changes the application of the first current value A1 to the second actuator 26 to the second current value A2, with the first current value A1 still being applied to the first actuator 25. The second actuator 26 then swings the optical member 20 about the second swinging axis BX to achieve the operation state C where the image position P3 has been shifted along the first swinging axis AX by ½ pixel, as illustrated in FIG. 12. That is, an image is displayed at the image position P4 shifted from the image position P0 in the one direction ABXc along the ABX direction.

### Image Display in Case Where Motion Vector is Equal to or Less Than Threshold

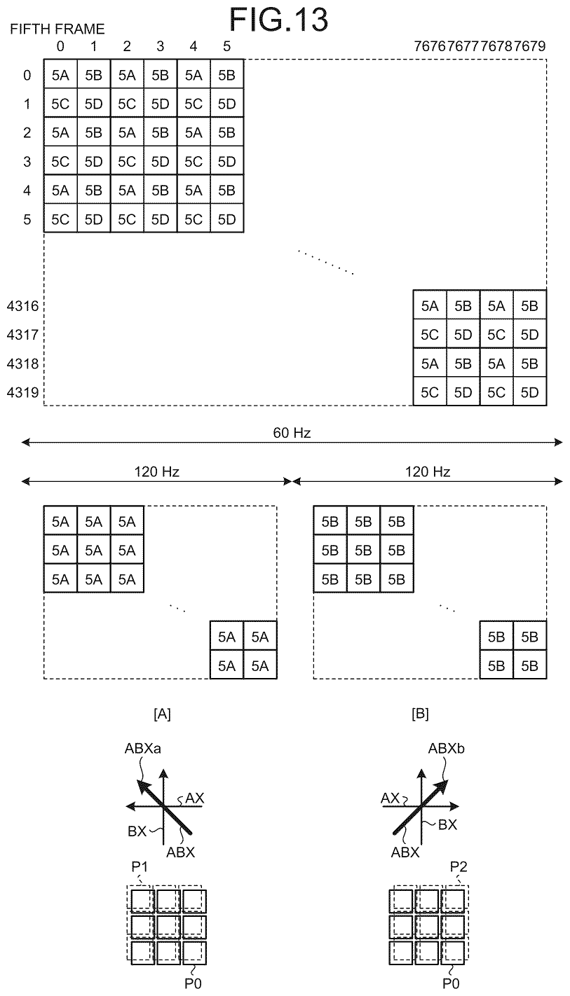

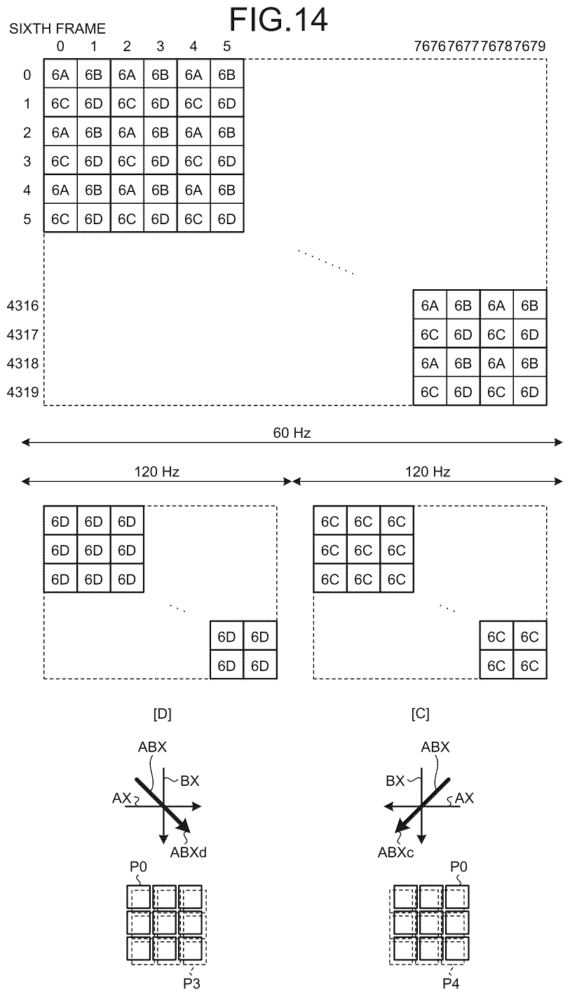

FIG. 13 and FIG. 14 are schematic diagrams illustrating an example of image display in a case where the motion vector is equal to or less than the threshold. In this embodiment, in the case where the motion vector V is equal to or less than the threshold, subframes are set for the second frame to be displayed so that only some of the pixels included in the second frame are each included in one of the subframes, and subframes are set for a frame (third frame) succeeding the second frame so that pixels different from pixels not included in the subframes of the second frame are each included in one of the subframes. The video signal processing circuit 160 then controls the display elements 106R, 106G, and 106B such that the subframes set for the second frame are successively displayed in the time period for display of the second frame, and controls the display elements 106R, 106G, and 106B such that the subframes set for the third frame are successively displayed in a time period for display of the third frame. On the basis of a synchronization signal input from the video signal processing circuit 160, the control circuit 14 generates a digital driving signal. On the basis of this driving signal, the driving circuit 16 drives the actuator 12B to swing the swinging unit 12A. A specific description will be made hereinafter.

As illustrated in FIG. 11 and FIG. 13, the video signal processing circuit 160 controls the display elements 106R, 106G, and 106B such that two subframes 5A and 5B (first subframe group) of the four subframes 5A, 5B, 5C, and 5D resulting from the division are successively displayed in the time period (60 Hz) for the display of the second frame (the frame F5 herein). The time period for the display of each of the subframes 5A and 5B is a time period (120 Hz) that is ½ of the time period (60 Hz) for the display of the frame F5. Subsequently, as illustrated in FIG. 11 and FIG. 14, the video signal processing circuit 160 controls the display elements 106R, 106G, and 106B such that two subframes 6D and 6C (a second subframe group) of four subframes 6A, 6B, 6C, and 6D resulting from division are successively displayed in the time period (60 Hz) for the display of the third frame (the frame F6 herein). The time period for the display of each of the subframes 6D and 6C is a time period (120 Hz) that is ½ of the time period (60 Hz) for the display of the second frame.

In this control, as illustrated in FIG. 2, FIG. 11, and FIG. 13, the control circuit 14 generates a digital driving signal on the basis of a synchronization signal input from the video signal processing circuit 160 and the driving circuit 16 drives the actuators 25 and 26 on the basis of the driving signal. That is, as illustrated in FIG. 11, upon display of the subframe 5A, the driving circuit 16 applies the second current value A2 to the first actuator 25 and the second actuator 26. The second actuator 26 then swings the optical member 20 about the second swinging axis BX to achieve the operation state A where the image position P0 has been shifted along the first swinging axis AX by ½ pixel, as illustrated in FIG. 13. That is, an image is displayed at the image position P1 shifted from the image position P0 in the one direction ABXa along the ABX direction.

Thereafter, as illustrated in FIG. 11, upon display of the subframe 5B, the driving circuit 16 applies the first current value A1 to the second actuator 26, with the second current value A2 still being applied to the first actuator 25. The second actuator 26 then swings the optical member 20 about the second swinging axis BX to achieve the operation state B where the image position P1 has been shifted along the first swinging axis AX by ½ pixel, as illustrated in FIG. 13. That is, an image is displayed at the image position P2 shifted from the image position P0 in the one direction ABXb along the ABX direction.

Thereafter, as illustrated in FIG. 11, upon display of the subframe 6D, the driving circuit 16 changes the electric current value to the first current value A1 with the application of the second current value A2 to the first actuator 25 still being stopped, and keeps the first current value A1 being applied to the second actuator 26. The first actuator 25 then swings the optical member 20 (see FIG. 3) about the first swinging axis AX to shift the image position P2 along the second swinging axis BX by ½ pixel and achieve the operation state D, as illustrated in FIG. 14. That is, an image is displayed at the image position P3 shifted from the image position P0 in the one direction ABXd along the ABX direction.

Thereafter, as illustrated in FIG. 11, upon display of the subframe 6C, the driving circuit 16 changes the application of the first current value A1 to the second actuator 26 to the second current value A2, with the first current value A1 still being applied to the first actuator 25. The second actuator 26 then swings the optical member 20 about the second swinging axis BX to achieve the operation state C where the image position P3 has been shifted along the first swinging axis AX by ½ pixel, as illustrated in FIG. 14. That is, an image is displayed at the image position P4 shifted from the image position P0 in the one direction ABXc along the ABX direction.

As described above, in this embodiment, the number of subframes in the frame is set on the basis of the motion vector V of the moving area. Setting the subframes and displaying the images per subframe as described above enables adequate display with desired gradation. Furthermore, setting the number of subframes from the motion vector V of the moving area enables the number of subframes to be set according to the motion vector V, that is, on the basis a result of determination of whether a moving image is to be displayed, and the moving image is thus able to be displayed adequately. What is more, in this embodiment, the number of subframes in the case where the motion vector V is larger than the threshold is made larger than the number of subframes in the case where the motion vector V is equal to or less than the threshold. Therefore, in a case of a moving image having a large motion vector V, for example, increasing the number of subframes enables the frame rate to be increased and the moving image to be displayed smoothly. However, in the case where the number of subframes is large, the time period of one subframe is short and predetermined gradation needs to be displayed in a short period of time. Even if voltage is applied to an optical modulation element using liquid crystal, the modulation factor of the liquid crystal element does not immediately change to a value according to the voltage applied and changes comparatively slowly. Therefore, display with the predetermined gradation may be unable to be achieved in a short period of time, and the resolution may be degraded due to a blur caused by, for example, a change to brightness of the next subframe time period during a shift of the display position. By contrast, in this embodiment, in a case where a still image having a small motion vector V is to be displayed, decreasing the number of subframes enables adequate display while minimizing display during a shift of a display position and enables display of an image that is less degraded in resolution and is rich in gradation.

According to the above description, the image position (the image positions P1 to P4 in this example) is mechanically switched by the swinging unit 12A but switching of the image position is not limited to this example. For example, the image position may be switched according to a combination of a liquid crystal element and a birefringence element.

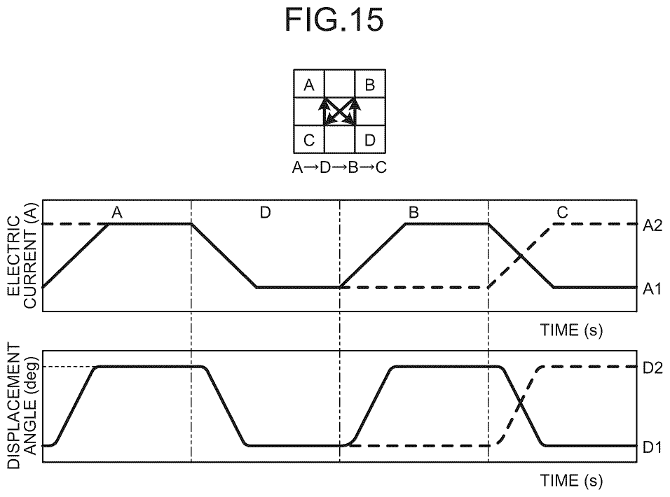

Furthermore, according to the above description, the subframes are set so that the pixels A, B, D, and C are displayed in this order, but the order of pixels displayed is not limited to this example and any order may be adopted. FIG. 15 is a schematic diagram illustrating another example of the order of pixels displayed. For example, as illustrated in FIG. 15, subframes may be set so that the pixels A, D, B, and C are displayed in this order.

### Second Embodiment

A method of extracting a moving area and a method of obtaining a motion vector V, according to a second embodiment are different from those of the first embodiment. Description of any configuration or processing according to the second embodiment and similar to that of the first embodiment will be omitted.

In the second embodiment, the control unit 170 obtains image data on a first frame and image data on a second frame. On the basis of the image data on the first frame and the image data on the second frame (by comparing the image data on the first frame and the image data on the second frame to each other), the control unit 170 calculates a motion vector V and a moving area.

Specifically, on the basis of the image data on the first frame and the image data on the second frame, the control unit 170 extracts the moving area that is an area that is moving in the image data, that is, an area where the motion vector V is generated. That is, in the second embodiment, the control unit 170 calculates the motion vector V on the basis of the image data on the first frame and the image data on the second frame, and extracts the moving area that is an area where the motion vector V is larger than a predetermined value (for example, larger than zero). Without being limited to using a motion vector V including both an amount of movement and a direction of the movement in setting subframes, only largeness of movement (an amount of movement) between the first frame and the second frame may be used in the setting of the number of subframes. Any method of calculating a motion vector V may be adopted in the second embodiment and a known technique may be used. For example, a block matching method may be used in calculating a motion vector V. In the block matching method, for example, an image is divided into plural blocks, correlation calculation between the first frame and the second frame may be performed per block, and a motion vector V is calculated from a correlation value from the correlation calculation. A block having a motion vector V larger than a predetermined value may then be calculated as a moving area. Furthermore, the moving area, the motion vector V, and the amount of movement in the second embodiment may be obtained from an external device via a communication unit not illustrated in the drawings. Furthermore, without being limited to the area where the motion vector V is generated, the moving area may be an area where an amount of movement is generated.

### Effects

As described above, the display device according to the embodiment includes the video signal processing circuit (processing unit) 160 that controls the display elements 106 on the basis of image data, and the control unit 170 that controls the video signal processing circuit (processing unit) 160, and the control unit 170 obtains an amount of movement from image data in a first frame and image data in a second frame after the first frame, sets, on the basis of the amount of movement, the number of subframes for the second frame, the subframes being for displaying some of pixels included in the image data on the second frame, and causes the video signal processing circuit (processing unit) 160 to control the display elements 106 such that the subframes set for the second frame are displayed in a time period for display of the second frame. Therefore, a moving image is able to be displayed smoothly with adequate gradation maintained.

Furthermore, the display device according to the embodiment sets the number of subframes larger in a case where the amount of movement is larger than a predetermined threshold, than the number of subframes set in a case where the amount of movement is equal to or less than the threshold. Therefore, increasing the number of subframes increases the frame rate and enables the moving image to be displayed smoothly.

Furthermore, the larger a moving area that is an area where the amount of movement is generated, the smaller the threshold set by the control unit 170 of the display device according to the embodiment. Therefore, degradation of the resolution of the moving image is able to be minimized.

Furthermore, in the display device according to the embodiment, in a case where the control unit 170 has determined that the amount of movement is larger than the threshold, the control unit 170 sets the subframes so that all of the pixels included in the second frame are each included in one of the subframes, and in a case where the control unit 170 has determined that the amount of movement is equal to or less than the threshold, the control unit 170 sets the subframes so that only some of the pixels included in the second frame are each included in one of the subframes. Therefore, a moving image is able to be displayed smoothly with adequate gradation maintained.

Furthermore, in the display device according to the embodiment, in the case where the control unit 170 has determined that the amount of movement is equal to or less than the threshold, the control unit 170 sets subframes for a third frame succeeding the second frame so that pixels of the third frame are each included in one of the subframes of the third frame, the pixels being different from pixels not included in the second frame. Therefore, a moving image is able to be displayed smoothly with adequate gradation maintained.

Furthermore, the display device according to the embodiment further has the swinging unit 12A having the optical member (optical unit) 20 where the light L is incident on, the actuator 12B capable of swinging the swinging unit 12A, and the driving unit that drives the actuator 12B in synchronization with processing by the video signal processing circuit (processing unit) 160. Therefore, a moving image is able to be displayed smoothly with adequate gradation maintained.

Furthermore, the display method according to the embodiment includes a step of obtaining an amount of movement from image data in a first frame and image data in a second frame after the first frame, a step of setting, on the basis of the amount of movement, the number of subframes for the second frame, the subframes being for displaying some of pixels included in the image data on the second frame, and a step of controlling the display elements 106 such that the subframes set for the second frame are displayed in a time period for display of the second frame. Therefore, a moving image is able to be displayed smoothly with adequate gradation maintained.

In the above described embodiment, the optical member 20 is configured to be swingably supported by the first axis portions 23 along the first swinging axis AX and swingably supported by the second axis portions 24 along the second swinging axis BX, but the embodiment is not limited to this configuration.

The display device 1 according to the embodiment has been described thus far, but implementation in various different modes other than the above described embodiment is possible.

The components of the display device 1 have been functionally and/or conceptually illustrated in the drawings, and are not necessarily configured physically as illustrated in the drawings. That is, the specific form of each device is not limited to the one illustrated in the drawings, and all or part of each device may be functionally or physically separated or integrated in any units according to, for example, the processing load on the device and the use situation of the device.

The configuration of the display device 1 is implemented as software, for example, by a program loaded into a memory. With respect to the embodiment, functional blocks implemented by cooperation among these pieces of hardware or pieces of software have been described above. That is, these functional blocks may be implemented in any of various forms, by hardware only, software only, or a combination of hardware and software.

An embodiment enables adequate display of a moving image with adequate gradation maintained.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A display device, comprising:
a processing unit that controls a display element on the basis of image data; and
a control unit that controls the processing unit, wherein
the control unit
obtains an amount of movement from the image data in a first frame and the image data in a second frame after the first frame,
sets the number of subframes for the second frame on the basis of the amount of movement, the subframes being for display of some of pixels included in the image data on the second frame, and
causes the processing unit to control the display element such that the subframes set for the second frame are displayed in a time period for display of the second frame.

2. The display device according to claim 1, wherein the control unit sets the number of subframes larger in a case where the amount of movement is larger than a predetermined threshold, than the number of subframes set in a case where the amount of movement is equal to or less than the threshold.

3. The display device according to claim 2, wherein the larger a moving area that is an area where the amount of movement has been generated, the smaller the threshold set by the control unit.

4. The display device according to claim 2, wherein the control unit
sets the subframes so that all of the pixels included in the second frame are each included in one of the subframes in a case where the control unit has determined that the amount of movement is larger than the threshold, and
sets the subframes so that only some of the pixels included in the second frame are each included in one of the subframes in a case where the control unit has determined that the amount of movement is equal to less than the threshold.

5. The display device according to claim 4, wherein in the case where the control unit has determined that the amount of movement is equal to or less than the threshold, the control unit sets the subframes so that pixels of a third frame succeeding the second frame are each included in one of subframes of the third frame, the pixels being different from pixels not included in the second frame.

6. The display device according to claim 1, further comprising:
a swinging unit having an optical unit where light is incident on;
an actuator capable of swinging the swinging unit; and
a driving unit that drives the actuator in synchronization with processing by the processing unit.

7. A display method, including:
a step of obtaining an amount of movement from image data in a first frame and the image data in a second frame after the first frame;
a step of setting the number of subframes for the second frame on the basis of the amount of movement, the subframes being for display of some of pixels included in the image data on the second frame; and
a step of controlling a display element such that the subframes set for the second frame are displayed in a time period for display of the second frame.
